(19) United States
(12) Patent Application Publication
(10) Pub. No.: US 2023/0334579 A1
(43) Pub. Date: Oct. 19, 2023

(54) COMPUTER-IMPLEMENTED METHOD AND SYSTEM FOR DETERMINING A PROTECTION LEVEL AND OPTIMAL INSURANCE COVER

(71) Applicant: ONESPARK (PTY) LTD, Sandown, Sandtor (ZA)

(72) Inventors: Francis Arthur GILL, Oaklands (ZA); Gregory Warren SMITH, Morningside (ZA); Josh Tana KAPLAN, Johannesburg (ZA)

(21) Appl. No.: 18/025,789

(22) PCT Filed: Sep. 15, 2021
(86) PCT No.: PCT/IB2021/058388

§ 371 Date: Mar. 10, 2023

(30) Foreign Application Priority Data
Oct. 9, 2020 (ZA) 2020/06270
Oct. 9, 2020 (ZA) 202006270

(51) Int. Cl. G06Q 40/08

(52) U.S. Cl. CPC G06Q 40/08

(57) ABSTRACT

A system for determining a protection level and optimal insurance cover for a client includes at least one computer and a processor. The system receives current cover data for at least one current insurance policy associated with the client or input data in respect of a possible insurance policy for the client. The system generates benchmark cover data associated with proposed insurance cover for the client. A processor compares the current cover data, or the input data, with the benchmark cover data in order to determine a protection level of the client. Protection level data is generated. The protection level data may include a maximum protection level obtainable by the client if a premium indicated by the client as affordable is insufficient for the client to obtain a benchmark cover amount or benchmark cover level.

This application claims priority to South African patent application number 2020/05735, filed on 16 Sep. 2020, and to South African patent application number 2020/06270, filed on 9 Oct. 2020, both of which are incorporated by reference herein.

### FIELD OF THE INVENTION

The invention relates to a computer-implemented method and system for determining a protection level of a client in an insurance environment. The invention also relates to a computer-implemented method and system for determining optimal insurance cover.

### BACKGROUND TO THE INVENTION

It can be difficult for a client to ascertain the appropriate level of protection, or cover, required when taking out an insurance product. For instance, when taking out life insurance, the client may struggle to determine the appropriate benefits to have included in the policy (e.g. cover against death, illness, disability and the like) as well as the appropriate monetary value to select for each benefit. This difficulty is caused by a number of factors, including (but not limited to) the large number of different products, benefits and options available in the market, their nuanced features, varying and often technical claim definitions, intricate terms and conditions, as well as the client’s uncertainty as to their own needs and requirements.

Given the complex and/or time-consuming nature of this exercise, clients often instruct financial advisers to assist them in determining the level of cover required and/or in taking out the appropriate insurance products on their behalf. However, a problem with this approach is that, on the one hand, the client typically does not know how to calculate their financial and insurance needs, while on the other hand, the financial adviser may lack the information and time (and sometimes the skill) required to calculate these financial and insurance needs. Due to this information asymmetry, the client cannot be sure that their financial and insurance needs are correctly and fully protected.

Relying on financial advisers to provide the correct amount, type of cover and benefits is also problematic in light of the incentives that usually exist for financial advisers to up-sell (and potentially mis-sell) to clients. In many cases, a financial adviser’s income is directly linked to both the amount of business they can secure and the size of the policies they sell. This means that the more they sell and/or the bigger the policies, the higher their income. As a result, there is a risk that financial advisers may de-prioritise the quality of their advice given the limited time they have with clients, instead focusing the majority of their time on selling and not providing optimal or near-optimal advice. This may also introduce unwanted bias or subjectivity into the process.

Even when a financial adviser does manage to calculate the client’s financial and insurance needs fairly accurately (e.g. the financial adviser takes the time to consult with the client, obtain the required information and understand the client’s needs in order to make a suitable calculation), the nature of many of the insurance products in the market remains a stumbling block. The Inventors have found that most insurance products have remained structurally unchanged over the past few decades or even longer. In particular, products and the cover they provide are generally static and fail to evolve with a client’s changing needs over time. As a result, many clients may face a cover shortfall during a policy term unless a financial adviser recalculates and adjusts their cover periodically. However, this is currently a time-consuming and cumbersome process. Furthermore, if it turns out that a client’s needs have reduced, the adviser may be discouraged from lowering their cover, as that could in turn have a negative impact on the adviser’s income.

As a result of these and other issues, there may be a gap between a client’s actual level of protection and the level of protection they would need if an insured event were to occur, and this gap may become progressively wider as the policy term advances. In South Africa, for instance, it is estimated that the so-called “life insurance gap” for individuals categorised as “millennials” is over R15 trillion (South African Rand) and appears to be growing every year.

Current technical systems used by insurers to calculate premiums and manage policies suffer from technical problems. In particular, these systems are in the Inventors’ experience not capable of appropriately calculating or estimating a protection level of a client at a given point in time, and appropriately calculating or estimating the optimal cover for the client based on the protection level and/or the financial means of the client. Accordingly, embodiments of the present invention aim to provide a technical solution capable of addressing the above issues, at least to some extent.

### SUMMARY OF THE INVENTION

Broadly, in accordance with the invention, there is provided a computer-implemented method of determining a protection level of a client, the method comprising:
receiving and/or accessing, by at least one computer, current cover data for at least one current insurance policy associated with the client;
generating, by a processor associated with the at least one computer, benchmark cover data associated with proposed insurance cover for the client;
comparing, by the processor, the current cover data with the benchmark cover data in order to determine a protection level of the client;
generating, by the at least one computer, protection level data based on the comparison between the current cover data and the benchmark cover data; and
generating, by the at least one computer, output indicative of the protection level and/or the protection level data.

Broadly, in accordance with the invention, there is also provided a computer-implemented method of determining optimal insurance cover for a client, the method comprising:
receiving and/or accessing, by at least one computer, input data in respect of a possible insurance policy, the input data including at least one benefit and a premium indicated by the client as being affordable;
generating, by a processor associated with the at least one computer, benchmark cover data associated with the possible insurance policy;
calculating, by the processor, a maximum protection level obtainable by the client based on the input data and the benchmark cover data, wherein the maximum protection level is a portion or a percentage of a benchmark cover amount or benchmark cover level forming part of the benchmark cover data;
generating, by the at least one computer, optimal cover data based on the maximum protection level; and
generating, by the at least one computer, output indicative of the optimal cover data and/or maximum protection level.

More specifically, in accordance with the invention, there is provided a computer-implemented method of determining a protection level and optimal insurance cover for a client, the method comprising:
receiving and/or accessing, by at least one computer, current cover data for at least one current insurance policy associated with the client or input data in respect of a possible insurance policy for the client, the current cover data including at least one benefit, and the input data including at least one benefit and a premium indicated by the client as being affordable;
generating, by a processor associated with the at least one computer, benchmark cover data associated with proposed insurance cover for the client;
comparing, by the processor, the current cover data or the input data with the benchmark cover data in order to determine a protection level of the client, wherein the protection level is a portion or a percentage of a benchmark cover amount or benchmark cover level forming part of the benchmark cover data;
generating, by the processor, protection level data based on the comparison between the current cover data or the input data and the benchmark cover data, wherein, in the case of a comparison between the input data and the benchmark cover data, the protection level data includes optimal cover data indicative of a maximum protection level obtainable by the client based on the comparison between the input data and the benchmark cover data, the premium affordable to the client being insufficient for the client to obtain the benchmark cover amount or benchmark cover level; and
generating, by the at least one computer, output indicative of the protection level data or the optimal cover data.

The current cover data may include data on one or more benefits. For each benefit, the current cover data may include a benefit cover amount. The processor may be configured to calculate the/each benefit cover amount.

The current cover data may include a current cover amount associated with the one or more insurance policies. The current cover amount may be the sum of or otherwise be indicative of or takes into account all of the benefit cover amounts in cases where the current cover data relates to a plurality of benefits. The processor may be configured to calculate the current cover amount.

The possible insurance policy may include a plurality of benefits. In such a case, the method may include determining a protection level per unit of premium for each benefit and giving preference to the benefit/s with a highest protection level per unit of premium so as to the maximise the protection level obtainable for the premium affordable to the client.

The benchmark cover data may include, for each benefit, a proposed protection level. In calculating the maximum protection level, only the benefit/s with the highest protection level per unit may be considered until the proposed protection level is reached for such benefit/s, before considering the benefit/s with lower protection levels per unit of premium.

The benchmark cover data may include a benchmark cover amount. The step of generating the benchmark cover data/amount may involve a calculation substantially as described in the Applicant’s South African Provisional Patent Application No. 2020/05735 entitled “COMPUTER-IMPLEMENTED METHOD AND SYSTEM FOR DYNAMICALLY ADJUSTING INSURANCE COVER AND AN INSURANCE PREMIUM”, the contents of which is incorporated by reference herein.

The benchmark cover data/amount may thus be calculated using a “needs-matched protection” or “pay-as-you-need” algorithm that determines the required protection based on the client’s needs at a particular point/period in time and dynamically adjusts as needs of the client change over time. As described in South African Patent Application No. 2020/05735, this algorithm projects the coverage needed for a client at different points/stages in their life, utilising a large number of personalised and economic data points. The output of this process may be used as the “benchmark” referred to herein, allowing the client to determine their true level of protection against this benchmark.

Accordingly, the method may include generating, by the processor, the benchmark cover amount using a needs-matched algorithm which assesses a financial need of the client which would result from the occurrence of an insured event during a specific period.

However, any other suitable “benchmark” may be used or proposed by the insurer depending on the insurance cover it proposes to the client and the Applicant’s needs-matched protection” or “pay-as-you-need” algorithm is an example only. The “current” cover data may relate to a selected policy or to an actual policy currently held by the client.

The method may further include allocating a weighting to each benefit (in cases where a plurality of benefits is assessed). Calculating the current cover amount may include allocating a weighting to each benefit and aggregating the benefits accordingly to arrive at the current cover amount. The benchmark cover amount may consist of a number of individual benchmark benefit amounts, each associated with one of the benefits in question. Calculating the benchmark cover amount may include allocating a weighting to each benefit, being the same weighting used during the current cover amount calculation, and aggregating the benefits accordingly to arrive at the benchmark cover amount.

The comparison between the current cover data and the benchmark cover data may include comparing the current cover amount with the benchmark cover amount, as calculated by the processor.

Generating the protection level data may include expressing the current cover amount as a percentage, fraction, portion or level of or relative to the benchmark cover amount.

Generating the protection level data may include generating a summary statistic providing an overview of the current cover data compared to the benchmark cover data or an overview of the maximum protection level obtainable for the premium affordable to the client. This may be the output referred to above.

The insurance policy or policies assessed may include one or more of life cover, disability cover, income protection, illness cover, health insurance, general or short term cover, or the like.

In some embodiments, the at least one computer may be configured to carry out the “protection level calculation” (i.e. determining the protection level of the client) again each time there is a change in either the benchmark cover or current cover. The at least one computer may be configured to detect such a change and to recalculate the protection level, as described above, in response to the change.

Broadly, in accordance with the invention there is also provided a system for determining a protection level of a client, the system comprising at least one computer and a processor, the system being configured to:
receive and/or access current cover data for at least one current insurance policy associated with the client;
generate, using the processor, benchmark cover data associated with proposed insurance cover for the client;
compare, using the processor, the current cover data with the benchmark cover data in order to determine a protection level of the client;
generate protection level data based on the comparison between the current cover data and the benchmark cover data; and
generate output indicative of the protection level and/or the protection level data.

Broadly, in accordance with the invention there is also provided a system for determining optimal insurance cover for a client, the system comprising at least one computer and a processor, the system being configured to:
receive and/or access input data in respect of a possible insurance policy, the input data including at least one benefit and a premium indicated by the client as being affordable;
generate, using the processor, benchmark cover data associated with the possible insurance policy;
calculate, using the processor, a maximum protection level obtainable by the client based on the input data and the benchmark cover data, wherein the maximum protection level is a portion or a percentage of a benchmark cover amount or benchmark cover level forming part of the benchmark cover data;
generate optimal cover data based on the maximum protection level; and
generate output indicative of the optimal cover data and/or maximum protection level.

More specifically, in accordance with the invention, there is also provided a system for determining a protection level and optimal insurance cover for a client, the system comprising at least one computer and a processor, the system being configured to:
receive and/or access current cover data for at least one current insurance policy associated with the client or input data in respect of a possible insurance policy for the client, the current cover data including at least one benefit, and the input data including at least one benefit and a premium indicated by the client as being affordable;
generate, by the processor, benchmark cover data associated with proposed insurance cover for the client;
compare, by the processor, the current cover data or the input data with the benchmark cover data in order to determine a protection level of the client, wherein the protection level is a portion or a percentage of a benchmark cover amount or benchmark cover level forming part of the benchmark cover data;
generate, by the processor, protection level data based on the comparison between the current cover data or the input data and the benchmark cover data, wherein, in the case of a comparison between the input data and the benchmark cover data, the protection level data includes optimal cover data indicative of a maximum protection level obtainable by the client based on the comparison between the input data and the benchmark cover data, the premium affordable to the client being insufficient for the client to obtain the benchmark cover amount or benchmark cover level; and
generate output indicative of the protection level data or the optimal cover data.

It will be appreciated that the system may be configured to communicate with the client via an agent or intermediary, e.g. a financial adviser.

The invention extends to a computer program product for determining a protection level and/or optimal insurance cover for a client, the computer program product comprising at least one computer-readable storage medium having program instructions embodied therewith, the program instructions being executable by at least one computer to cause the at least one computer to carry out one or more of the techniques substantially as described above.

The computer-readable storage medium may be a non-transitory storage medium.

### BRIEF DESCRIPTION OF THE DRAWINGS

The invention will now be further described, by way of example, with reference to the accompanying drawings. In the drawings:

FIG. 1 is a schematic illustration of an embodiment of a system according to the invention;

FIG. 2 is a flow diagram illustrating certain steps and processes in a first exemplary method according to the invention;

FIG. 3 is a flow diagram illustrating certain steps and processes in a second exemplary method according to the invention; and

FIG. 4 is a block diagram of an exemplary computer system capable of executing a computer program product to provide functions and/or actions according to at least some aspects of the invention.

### DETAILED DESCRIPTION WITH REFERENCE TO THE DRAWINGS

The following description is provided as an enabling teaching of the invention, is illustrative of principles associated with the invention and is not intended to limit the scope of the invention. Changes may be made to the embodiments depicted and described, while still attaining results of the present invention and/or without departing from the scope of the invention. Furthermore, it will be understood that some results or advantages of the present invention may be attained by selecting some of the features of the present invention without utilising other features. Accordingly, those skilled in the art will recognise that modifications and adaptations to the present invention may be possible and may even be desirable in certain circumstances, and may form part of the present invention.

Embodiments of the present invention provide a computerised system configured to enable clients to determine their actual level of insurance cover/protection and also to obtain optimal cover based on a premium they are able to afford.

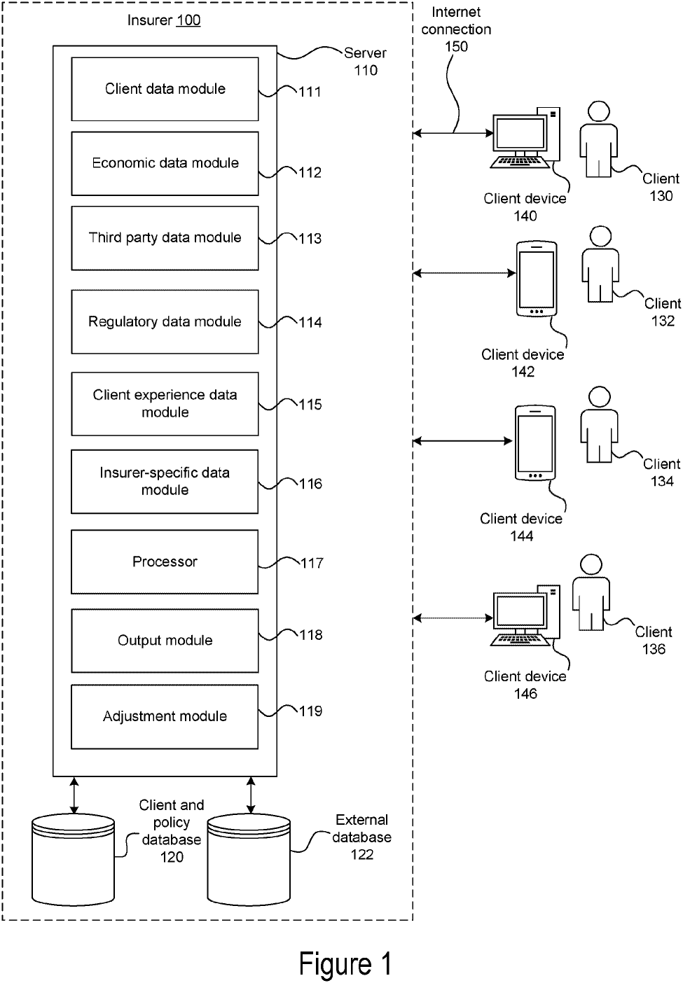

FIG. 1 shows a remotely accessible server (hereinafter “the server 110”) of an insurer 100. Insurance clients 130, 132, 134, 136 (including potential clients) are able to communicate with the insurer 100, e.g. via a suitable website or mobile application or other channels such as e-mail, in order to transmit information to and receive information from the server 110. It will be appreciated that these communications may be carried out for various purposes and over any suitable communications link, such as the Internet 150.

For purposes of this specification, the clients 130, 132, 134, 136 communicate with the insurer 100 in order to obtain quotes for and acquire (enter into agreements for) insurance products/policies, such as (but not limited to) life insurance and disability insurance. The clients 130, 132, 134, 136 may also periodically communicate with the insurer 100 to update certain data relating to their policies, e.g. provide updated personal and financial information on an annual basis. The clients 130, 132, 134, 136 may also communicate with the insurer 100 for the purpose of obtaining an indication of their protection level and/or the maximum cover they can obtain for a certain premium, as will become apparent from the further descriptions below.

The clients 130, 132, 134, 136 may make use of any suitable communications devices in order to communicate with the insurer 100, and the client devices 140, 142, 144, 146 (mobile phones and personal computers with suitable connectivity) are shown as examples in FIG. 1. At least some aspects of the invention may also be implemented without requiring such a connection 150 between a client and the insurer 100, e.g. a client (not shown) may travel to a physical branch of the insurer 100 or meet with a financial adviser and provide the necessary input data to the insurer 100 at the branch or via the financial adviser, allowing cover, premiums and protection levels to be calculated and adjusted as described in more detail below.

Typically, an insurance platform including a server like the server 110 in FIG. 1 may communicate with a large number of clients and third parties. However, for ease of reference and to illustrate aspects of the invention, an insurance policy interaction/transaction between the client 130 and the insurer 100 will be described below and reference will thus be made only to that particular client 130.

The server 110 may take various forms: it may include one or more computing devices and may be in a single location, distributed across various locations, hosted in a cloud-based environment, or combinations thereof.

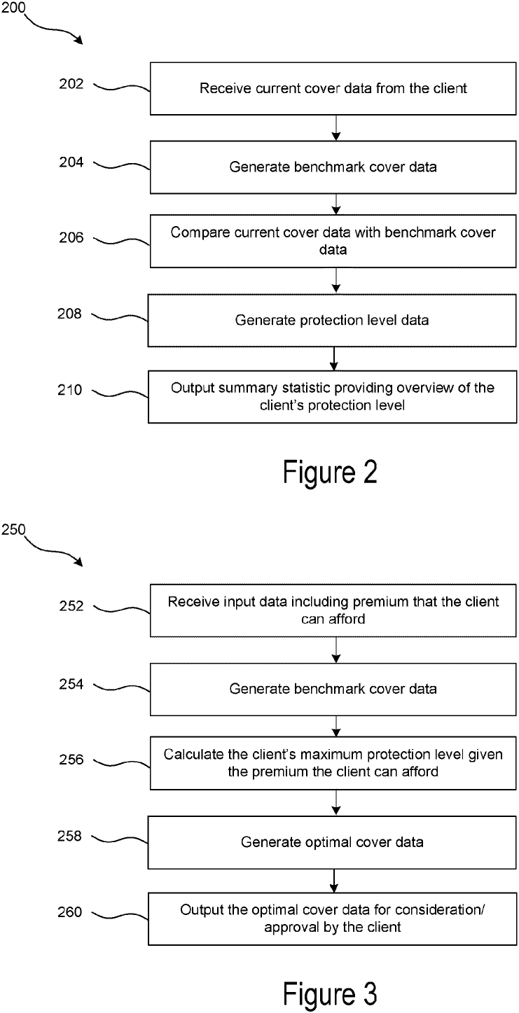

The server 110 includes a number of functional or logical components (referred to as “modules” below): a client data module 111, an economic data module 112, a third party data module 113, a regulatory data module 114, a client experience data module 115, an insurer-specific data module 116, a processor 117 (or multiple processors), an output module 118 and an adjustment module 119. The server 110 may, in practice, include many other functional/logical components, but the above modules 111-119 are focused on herein, again, to illustrate aspects of the invention. The configuration and functionality of the modules 111-119 are described in more detail with reference to the flow diagrams 200 and 250 in FIGS. 2 and 3 below.

The server 110 may also typically include, or be communicatively coupled to, a number of databases such as a client and policy database 120 with data internal to the insurer 100 and an external database 122 from which the insurer 100 draws external data, e.g. economic indicators, regulatory data, and the like.

The server 110 is configured to implement an algorithm which calculates “needs-matched protection” or “pay-as-you-need protection”, for instance (but not limited to), as described in South African Patent Application No. 2020/05735.

This type of algorithm projects the coverage needed for a client at different points/stages in their life, utilising a large number of personalised and economic data points. The output of this process may be used as the “benchmark” referred to in this specification, allowing the client 130 to see their current level of protection against this benchmark and to assist the client 130 in obtaining a maximum level of protection relative to a benchmark level.

The “needs-match protection” algorithm considers multiple variables to calculate the financial need of the client 130 at different ages or life stages and enables the adjustment of their cover up or down (or keep it constant) accordingly for each age/stage. This ensures that clients receive an appropriate level of cover to indemnify them should they suffer a qualifying life changing event (or other insured event). The variables referred to above may, for instance, include the following: client age, salary/income, tax payable now and in the future (changes in tax considerations over time), occupation, debt levels, existence and details of other life insurance plans, family composition and number of financial dependants, investments and how investments (including investment mix) will change over time. The adjustment module 119 is configured to re-assess and adjust these and other variables continuously or periodically. This type of algorithm is further explained in an example below.

In addition to the “needs-matched protection” algorithm, the server 110 is further configured to employ a protection level algorithm, which may in practice be presented to clients as a “Financial Need Protection Wheel” or some other graphical representation, allowing the client 130, through a simple summary statistic, to see how much protection they currently have, compared to how much protection they actually need. As a simplified example, if the client 130 selects (or already has) R1 million in cover, the server 110 may determine that they are under-protected and the graphical representation may show that they only have 20% of the protection they need, where their actual need is R5 million cover. The output module 118 may be configured to output the protection level of the client 130 in a simple, numerical and/or graphical manner, that allows for almost any client, no matter their level of education or understanding of their financial needs, to quickly and easily determine their level of financial protection.

Embodiments of the invention effect this in a personalised and individualised manner, which differs for each client and for each life stage. In the case of life insurance, the Inventors have found that this can assist not only in highlighting the “life insurance gap”, but can also provide a mechanism to help close this gap throughout a client’s lifetime.

The server 110 is further configured to add weightings to policy benefits. These weightings may dynamically change over the client’s life as their financial needs change, so as to show the client 130 what their real level of coverage is relative to their true financial and insurance needs on an ongoing basis.

Turning now specifically to FIG. 2, which illustrates an example methodology, at a first stage 202, the client 130 provides current cover data to the server 110. This typically includes the client’s current policy benefits and current cover amount/s (this may be an existing policy or simply one selected by the client 130 or proposed by the financial adviser of the client 130).

Then, at stage 204, benchmark cover data (including a benchmark cover amount) is generated by the server 110. As mentioned above, in this case the benchmark details are calculated using the “needs-matched protection” algorithm identified above. However, other methods may be employed without departing from the scope of the invention.

Turning again to stage 204, the client data module 111 firstly receives client input data relevant to the calculation of the benchmark cover data. This may include the age of the client 130, number of dependents, retirement age, occupation, gross salary, and the like. In respect of occupation, the server 110 may specifically make use of information such as qualifications, industry, location and work experience to calculate future expected changes to gross salary and tax without subsequent client input. The economic data module 112 receives or accesses economic data relevant to the calculation of the benchmark cover data. This may include data such as a risk-free rate, relationship between asset return and risk-free rate, implied inflation over time, and the like. The third party data module 113 receives or accesses third party data (e.g. from an external database 122) so as to obtain an up to date view of certain details of the client 130, e.g. debt, spending, salary information, existing life insurance with other providers, and the like. The regulatory data module 114 assesses regulatory considerations such as tax which would impact the finances of the client 130. The above-described data are used by the processor 117 to determine the amount of cover actually required by the client 130, i.e. the benchmark cover amount. The processor 117 may be configured specifically to determine the amount of cover required for the present period, e.g. for the next year, and be further configured to do so on an ongoing/dynamic basis for subsequent periods, that is, without the client 130 having to input any updated values at a subsequent stage.

As mentioned above, the adjustment module 119 is configured to facilitate adjustment of the cover amount as required for subsequent periods, based on the changing needs of the client 130.

In this way, the server 110 is configured to determine the amount of insurance cover (life cover amount, disability cover amount, income protection amount and/or illness cover amount) the client 130 needs at each stage of their life. This process may be employed continuously or periodically throughout the relationship with the client 130 so as to ensure the cover amount associated with the client 130 is adjusted as the client’s needs change over time.

At stage 206, the current cover of the client 130 is compared with the benchmark cover calculated by the server 110 in stage 204. Protection level data is then generated (stage 208) based on the results of this comparison and, at stage 210, the server 110 outputs a summary statistic providing an overview of the current protection level of the client 130. The protection level algorithm provides an up to date view of the level of financial and insurance protection the client 130 enjoys or would enjoy under a policy, allowing them to easily assess whether their level of cover is appropriate for their needs. It thus compares the client’s actual/selected cover (level of protection) to the benchmark level of protection for their given circumstances (i.e. the protection determined by the server 110 to be comprehensive and appropriate).

In preferred implementations, the protection level algorithm is re-executed and the protection level is updated each time there is a change in either the benchmark cover and/or current cover of the client 130.

In order to illustrate certain aspects of the protection level algorithm, specific, non-limiting examples are provided below, again with reference to the client 130. South African Rand (R) is used as an exemplary currency.

### Scenario 1

In a first simplified example, the algorithm uses the client’s actual level of cover for all benefits selected and divides this by the proposed/benchmark level of cover for all benefits. In this example, the client 130 has selected R500,000 cover against death (life insurance) and R800,000 cover against disability (disability insurance), while the proposed level of cover (the benchmark referred to above) is R1,000,000 and R2,000,000 respectively (the latter having been calculated using the method of stage 204). In this case, the protection level would be 43.33% (calculated as follows: (R500,000 + R800,000) / (R1,000,000 + R2,000,000)).

### Scenario 2

Where benefits with a series of benefit payments are relevant, a value may be placed on this series of benefit payments based on the client’s risk profile (e.g. age, gender, income, education, health, smoker status, etc.), economic factors (inflation, risk free rates, etc.) and benefit payment specific information (e.g. when the benefit payments are made, how the benefit payments change over time, etc.).

In this example, in terms of current cover data, the client has selected R500,000 cover against death (life insurance), R250,000 cover against illness (illness insurance) and R20,000 cover against disability to replace their income going forward (income insurance which provides a series of benefit payments), while the proposed level of cover (based on the benchmark cover data) is R1,000,000, R400,000 and R30,000 respectively. Here the value of the series of benefit payments where the benefit amount is R1 (based on the client’s risk profile, economic factors and benefit specific information) is equal to R240 (assumed in order to simplify the calculation). The protection level would be 64.53% (calculated as follows: (R500,000 + R250,000 + R20,000 * 240) / (R1,000,000 + R400,000 + R30,000 * 240)).

As alluded to above, a weighting may be assigned to each of the benefits used in the protection level algorithm. For example, the weighting may be the probability associated with each of the events covered or certain percentages for each of the benefits based on a client’s specific profile and the importance of the relevant benefit at that stage of their life, say 60% to life cover and 40% to other benefits for a 25 year old.

If the probability associated with the event is employed, an indirect way of allowing for this weighting may be to use the risk premium (theoretical cost of risk associated with providing cover against certain events at a specified benefit level, i.e. the probability of an event occurring multiplied by the benefit level) or other premiums (e.g. the premium that the client is charged that allows for risk, expenses and profit; this may however result in a slightly distorted results). Alternatively, this may be achieved through extending the aforementioned calculation method through allowing for the probability of an event occurring (which is based on the specific event covered and the client’s risk profile).

Continuing from Scenario 2 and adding the weightings feature, the probability of the event has been used as the weighting in this example. It is assumed that the probability of the client 130 dying is 0.1%, the probability of the client 130 becoming ill is 0.075% and the probability of becoming disabled and unable to work is 0.05%. In such a case, the level of protection would be 63.01% (calculated as follows: (R500,000 * 0.1% + R250,000 * 0.075% + R20,000 * 240 * 0.05%) / (R1,000,000 * 0.1% + R400,000 * 0.075% + R30,000 * 240 * 0.05%)).

As mentioned above, the system is not only configured to calculate protection level against a benchmark / proposed cover, it is also able to calculate the maximum protection that the client 130 could obtain should the client 130 only be able to afford a specific premium. More specifically, where premium affordability is a concern (e.g. the client 130 cannot afford the premium associated with the “benchmark” / ideal benefits based on their needs at that stage of their life), the protection level output can be used as an input in order to determine the optimal insurance cover that can be afforded for a given premium. This is done through determining the level of protection added per unit of premium for each of the relevant benefits. In this description, and merely as an example, the unit of premium is South African Rand.

Turning now specifically to FIG. 3, which illustrates an example methodology, at a first stage 252, the client 130 provides the server 110 with the premium. This would typically be the maximum amount that the client 130 can afford or is willing to pay for the insurance cover.

Then, at stage 254, the server 110 generates benchmark cover data which is used together with available premium to calculate the maximum protection level (stage 256). Based on the maximum protection level obtainable, the server 110 generates optimal cover data (stage 258) and outputs this data to the client 130 for consideration/approval at stage 260. The optimal cover data may typically include an optimal set or combination of benefits which would maximise the protection level for the given premium.

In order to illustrate certain aspects of the optimal cover calculation process, specific, non-limiting examples are provided below, again with reference to the client 130.

### Scenario 3

It is assumed that the client 130 is only interested in two benefits (or only two benefits are relevant): life insurance and illness insurance and the client can only afford to pay a premium of R80 per month.

It is further assumed that R1,000,000 life insurance cover, which has been calculated as the benchmark/ideal protection, has a monthly premium of R100 (i.e. R1 life insurance premium would be able to purchase R10,000 life insurance cover) and R400,000 illness insurance cover, which has been calculated as the benchmark/ideal protection, has a monthly premium of R100 (i.e. R1 illness insurance premium would be able to purchase R4,000 illness insurance cover). It is also assumed, as in Scenario 2 above, that the probability of the client 130 dying is 0.1% and the probability of the client 130 becoming ill is 0.075%.

As in Scenario 2, the probability of each event occurring is used as the weighting for purposes of determining the protection level (and protection level increases) in this example.

Using the same protection level algorithm concept, R1 of life insurance premium increases the level of protection by 0.77% (calculated as follows: (R10,000 * 0.1%) / (R1,000,000 * 0.1% + R400,000 * 0.075%)). The aforementioned value is calculated through inserting only the amount of cover added per unit of premium into the formula used to determine the level of protection. Similarly, R1 of illness insurance premium increases the level of protection by 0.23% (calculated as follows: (R4,000 * 0.075%) / (R1,000,000 * 0.1% + R400,000 * 0.075%).

The benefit with the highest level of protection per unit (Rand) of premium is added until the proposed level for the respective benefit is reached or the premium that the client 130 can afford is reached, whichever occurs first. If the premium that the client 130 can afford has not been reached after reaching the proposed level of cover for the abovementioned benefit, the benefit with the next highest level of protection per unit of premium is added until the proposed level for the respective benefit is reached or the premium that the client 130 can afford (allowing for any benefits added before) is reached, whichever occurs first.

As the client can only afford a R80 premium, the client will not be able to afford the full R200 premium that would be required to pay for the R1,000,000 life cover and the R400,000 illness cover. Thus, the cover against death is added first, since it has the highest level of protection per unit of premium (0.77% for life insurance compared to 0.23% for illness insurance). The client 130 can only afford to buy R800,000 of cover at R80, giving the client 130 a 61.54% (R80 * 0.77%) level of protection (using the premium for the benefit and the level of protection added for each R1 of premium for the relevant benefit). If instead the client 130 could afford a R150 premium, all cover against death could be afforded and R50 would be left with which cover against illness could be purchased (R200,000), giving the client an 88.46% (R100 * 0.77% + R50 * 0.23%) level of protection.

### Scenario 4

Where benefits have the same level of protection per unit of premium, they may be added in the ratio of their premiums until the proposed level for the respective benefits are reached or the premium that the client 130 can afford is reached, whichever occurs first.

It is assumed that the client 130 can afford a R100 premium, the proposed level of cover against death is R1,000,000 (with a R100 monthly premium), the proposed level of cover against illness is R400,000 (with a monthly premium of R100) and the proposed level of cover against disability to replace income going forward is R30,000 (with a monthly premium of R360; R1 of income insurance premium would be able to purchase R83.33 income insurance cover). The calculations are as follows:
R1 of life insurance premium increases the level of protection by:
   (R10,000 * 0.1%) / (R1,000,000 * 0.1% + R400,000 * 0.075% + R30,000 * 240 * 0.05%) = 0.20%
R1 of illness insurance premium increases the level of protection by:
   (R4,000 * 0.075%) / (R1,000,000 * 0.1%+ R400,000 * 0.075% + R30,000 * 240 * 0.05%) = 0.06%
R1 of income insurance premium (disability) increases the level of protection by:
   (R83.33 * 240 * 0.05%) / (R1,000,000 * 0.1% + R400,000 * 0.075% + R30,000 * 240 * 0.05%) = 0.20%

The cover against death and disability (to replace income going forward) are added first (in a 100:360 or 1:3.6 ratio in line with the ratio of their premiums), since they have the highest level of protection per rand of premium (0.2%). This is done until a R100 premium is reached. Here R21.74 (R100 * R100/ (R100 + R360)) is used to buy cover against death (purchasing R217,391 = R21.74 / R100 * R1,000,000 life insurance cover). R78.26 (R100 * R360 / (R100 + R360)) is used to buy cover against disability (to replace income going forward). This purchases R6,521.74 (R78.26 / R360 * R30,000) income insurance cover. No illness cover is purchased.

If instead the client could afford a R500 premium, all cover against death and disability (to replace income going forward) could be afforded and R40 would be left with which cover against illness could be purchased (R160,000 = R40 / R100 * R400,000).

In calculating cover and/or premiums in embodiments of the invention, the client data module 111 may also be configured to consider risk-specific client data, e.g. dangerous pursuits, health status, smoker status, and the like. The client experience data module 115 and the processor 117 may analyse data relating to client experience. The client experience data may include experience indicators, which may include indicators of lapse experience, cancellation experience, mortality experience and/or morbidity experience. The processor 117 may be configured to analyse past experience data relating to the client experience indicator/s and future experience data relating to expected future changes in the client experience indicator/s in order to calculate the premium. The experience data may relate to instances, levels or rates of policy lapses, policy cancellations, client mortality and/or client morbidity, or data derived therefrom. Insurer-specific data may be accessed by the insurer-specific data module 116. This may be considerations specific to the insurer 100 such as absolute profit, profit emergence, expenses incurred, and the like.

### Needs-Matched Algorithm

As explained above, the benchmark cover amount or benchmark cover level may be determined using a needs-matched algorithm which assesses a financial need of the client which would result from the occurrence of an insured event during a specific period. This is explained in more detail below, in a non-limiting fashion.

Embodiments of the present invention may include computerised system which is configured to adjust a client’s insurance cover periodically, e.g. each year, to match their changed needs, thus ensuring that the client only pays for what they require during each particular period. Embodiments of the invention may utilise algorithms, such as machine learning algorithms, which dynamically track a client’s needs over their life.

A specific, non-limiting example is provided below, with reference to the client 130. South African Rand (R) is used as an exemplary currency to illustrate aspects of the invention.

In this example, the facts at onset of the policy are:
The client 130 is a 30 year old who earns R25 000 per month (gross salary) with one financial dependant (spouse).
The client 130 has a R1m home loan and a R200 000 car loan.
The client 130 is an accountant and plans to retire at age 65.

Based on data, x% (where x is less than 100% and dependent on number and type of dependents) of the client’s income would be required by their spouse in the event of their death (100% required in the event of disability).

The needs-match algorithm employed by the server 110 projects forward their gross salary, allowing for age and occupation specific increases over and above implied inflation. These may be significantly higher at younger ages, e.g. for certain professionals like accountants. In different professions, increases or decreases as age increases may differ. The server 110 calculates their net salary allowing for changes in assumed taxation of personal income (based on historic changes in income tax as well as expected future tax changes).

Settlement of outstanding loans is allowed for and impacts the stream of “income” required for the period over which the loans were expected to be repaid.

This gives an accurate view of the amounts required at different points in time until retirement if an insured event occurs.

The algorithm then determines the most suitable investment strategy that will provide the required amounts throughout: it starts with an age based asset allocation between equity (high and low dividend yield shares), bonds (fixed and index linked government and corporate bonds), property (listed property shares) and money market. The asset allocation is then adjusted to ensure that no assets need to be disposed of in the first three years to meet any liquidity requirements (in order to ensure that any capital gains are taxed as such and not taxed as income).

The return provided by these assets (after the appropriate tax has been paid and investment fees allowed for) is used to provide for the abovementioned amounts at the different points in time (based on return implied by government bond prices and the relationship of the various different types of return of different assets to the risk free rate). The amount required is determined such that the portfolio runs down to retirement age (allowing for rebalancing of the portfolio based on age and to ensure sufficient liquidity is maintained).

In calculating the amount of cover required, the processor 117 may thus determine or access an age appropriate investment strategy (based on research of investment strategies and how they change based on age) allowing for the split of the client’s asset pool between the main asset classes and within assets classes. The processor 117 may analyse future expected risk free rates (e.g. based on boot strapping government bonds based on their prices), the relationship between the risk free rate and return (income and capital gain) offered by different asset classes, the different applicable taxes (while adjusting the strategy appropriately to reduce and minimize tax as far as possible), and management of a client’s exposure to asset volatility (set at an acceptable level to ensure the client 130 or their family do not run into liquidity constraints).

The premium (for the following 12 months) is then be determined based on this cover amount.

The dynamic nature of the cover requires premiums to be changed as the need of the client 130 changes over time. This ensures that the premium in any given year does not seem unreasonable relative to the cover provided, the specific individual’s risk factors (age, gender, smoker status, income, occupation, health status, dangerous pursuits, family history, geographical location, etc.), economic assumptions, past experience, adjustment to allow for future expected differences in experience, regulatory considerations (impact of reserving requirements, specific taxation depending on policy classification, etc.) and company specific requirements (e.g. profit required, expenses incurred, profit emergence, etc.).

At policy anniversary, the adjustment module 119 adjusts the necessary client, economic and other details. If the client 130 does not manually update any information previously provided (and where information is not available from a third party), their gross salary would be projected forward using age and occupation (this may be expanded to include variables such as industry, location and others). The loan amounts would be run down based on the loan details if exact balances cannot be retrieved from another party. Tax assumptions would typically be updated and risk free rates (and the relationship of asset return to risk free rates) would also be updated.

A new cover amount, or a difference/change in cover amount, is then determined by the processor 117, using the steps already described above, for the new period. This could then be used as the new benchmark cover amount in embodiments of the invention.

Again, the premium for the new period would be determined as described above using the updated data and revised cover amount. This system thus offers a technical solution allowing for the implementation of an insurance policy in which the client is no longer “locked” into a long term, static contract as implemented by current technical systems, but essentially receives a dynamic short term contract where their cover automatically adjusts each year.

Embodiments of the invention thus provide a computerised, technical insurance product solution providing numerous advantages. Some of these advantages have already been identified above, and others are described below.

As explained above, current technical systems used by insurers to calculate premiums and manage policies suffer from technical problems. In particular, these systems are in the Inventors’ experience not capable of appropriately calculating or estimating a protection level of a client at a given point in time, and appropriately calculating or estimating the optimal cover for the client based on the protection level and/or the financial means of the client. These technical problems are addressed by embodiments of the invention, e.g. through the use of a protection level algorithm which can provide the client with an accurate indication of their protection level and/or maximum affordable protection.

This invention may enable and facilitate the “filling” of the insurance gap referred to above by ensuring that clients remain fully (or optimally) covered. Embodiments of the invention may provide a single metric allowing a client to gauge protection relative to an optimal structure for their unique situation.

Where premium affordability is a concern, embodiments of the invention allow clients to achieve the greatest/optimal level of protection for a given level of premium.

The protection level system described herein may provide a single and easily understandable measure which is personalised and tailored to the client’s unique situation, enabling clients to know and understand at what level they are protected against the various life changing events they may encounter. Embodiments of the invention may also assist clients in determining what the relative importance of the different benefits are, which may in turn assist clients in not choosing potentially less important benefits over more important benefits (importance being assessed here as having the most significant impact on their life) where premium affordability is a concern.

Embodiments of the invention may take into account the combined coverage of multiple benefits/products of a client. This ensures that each benefit amount proposed appropriately reflects the client’s needs and assists the client in optimising protection by selecting the best combination of benefits (e.g. if a client can only afford a certain premium, the system facilitates the efficient use of the funds available).

Embodiments of the invention may obviate the need for a client to rely solely on the advice of financial advisers.

While the examples above have focused on the life insurance industry, it will be appreciated that embodiments of the invention may be applied broadly across the insurance industry.

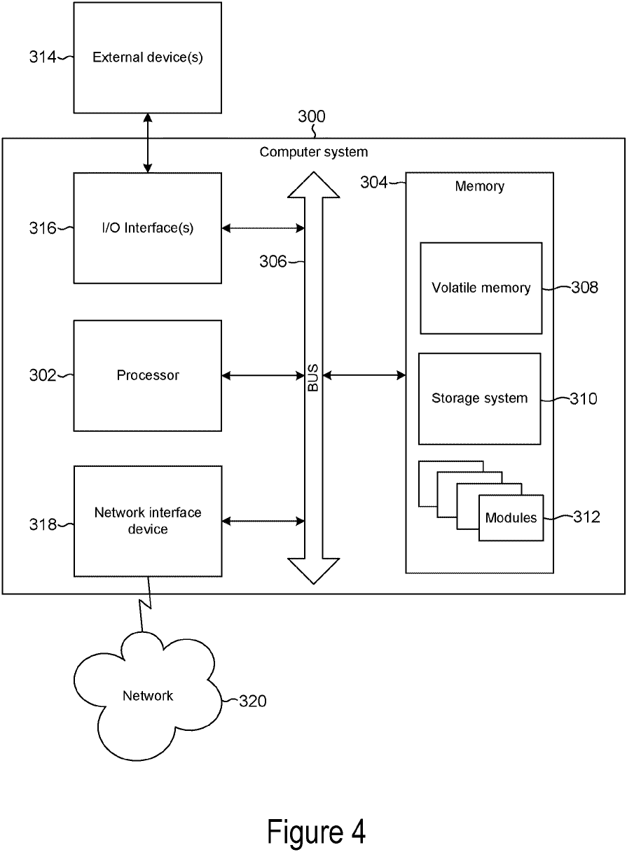

The techniques described above may be implemented in or using one or more computer systems, such as the computer system 300 shown in FIG. 4. The computer system 300 may be or include any suitable computer or server. The server 110 may include such a computer system 300. The computer system 300 may be implemented in distributed cloud computing environments where tasks are performed by remote processing devices that are linked through a communications network. In a distributed cloud computing environment, program modules executed by the computer system 300 may be located both locally and remotely.

In the example shown in FIG. 4, the computer system 300 has features of a general-purpose computer. These components may include, but are not limited to, at least one processor 302, a memory 304 and a bus 306 that couples various components of the system 300 including the memory 304 to the processor 302. The bus 306 may have any suitable type of bus structure. The computer system 300 may include one or more different types of readable media, such as removable and non-removable media and volatile and non-volatile media.

The memory 304 may thus include volatile memory 308 (e.g. random access memory (RAM) and/or cache memory) and may further include other storage media such as a storage system 310 configured for reading from and writing to a non-removable, non-volatile media such as a hard drive. It will be understood that the computer system 300 may also include or be coupled to a magnetic disk drive and/or an optical disk drive (not shown), or any other suitable type of drive, for reading from or writing to suitable non-volatile media. These may be connected to the bus 306 by one or more data media interfaces.

The memory 304 may be configured to store program modules 312. The modules 312 may include, for instance, an operating system, one or more application programs, other program modules, and program data, each of which may include an implementation of a networking environment. The components of the computer system 300 may be implemented as modules 312 which generally carry out functions and/or methodologies of embodiments of the invention as described herein. It will be appreciated that embodiments of the invention may include or be implemented by a plurality of the computer systems 300, which may be communicatively coupled to each other.

The computer system 300 may operatively be communicatively coupled to at least one external device 314. For instance, the computer system 300 may communicate with external devices 314 in the form of a modem, keyboard and display. These communications may be effected via suitable Input/Output (I/O) interfaces 316.

The computer system 300 may also be configured to communicate with at least one network 320 (e.g. the Internet or a local area network) via a network interface device 318 / network adapter. The network interface device 318 may communicate with the other elements of the computer system 310, as described above, via the bus 306.

The components shown in and described with reference to FIG. 4 are examples only and it will be understood that other components may be used as alternatives to or in conjunction with those shown.

Aspects of the present invention may be embodied as a system, method and/or computer program product. Accordingly, aspects of the present invention may take the form of hardware, software and/or a combination of hardware and software that may generally be referred to herein as “components”, “units”, “modules”, “systems”, “elements”, or the like.

Furthermore, aspects of the present invention may take the form of a computer program product embodied in one or more computer-readable storage medium having computer-readable program code embodied thereon. A computer-readable storage medium may, for instance, be an electronic, magnetic, optical, electromagnetic, infrared, or semiconductor system, apparatus, or device, or any suitable combination of the above. In the context of this specification, a computer-readable storage medium may be any suitable medium capable of storing a program for execution or in connection with a system, apparatus, or device. Program code/instructions may execute on a single device, on a plurality of devices (e.g., on local and remote devices), as a single program or as part of a larger system/package.

The present invention may be carried out on any suitable form of computer system, including an independent computer or processors participating on a network of computers. Therefore, computer systems programmed with instructions embodying methods and/or systems disclosed herein, computer systems programmed to perform aspects of the present invention and/or media that store computer-readable instructions for converting a general purpose computer into a system based upon aspects of the present invention, may fall within the scope of the present invention.

Chart(s) and/or diagram(s) included in the figures illustrate examples of implementations of one or more system, method and/or computer program product according to one or more embodiment(s) of the present invention. It should be understood that one or more blocks in the figures may represent a component, segment, or portion of code, which comprises one or more executable instructions for implementing specified logical function(s). In some alternative implementations, the actions or functions identified in the blocks may occur in a different order than that shown in the figures or may occur concurrently.

It will be understood that blocks or steps shown in the figures may be implemented by system components or computer program instructions. Instructions may be provided to a processor of any suitable computer or other apparatus such that the instructions, which may execute via the processor of the computer or other apparatus, establish or generate means for implementing the functions or actions identified in the figures.

1. A computer-implemented method of determining a protection level and optimal insurance cover for a client, the method comprising:
receiving and/or accessing, by at least one computer, current cover data for at least one current insurance policy associated with the client or input data in respect of a possible insurance policy for the client, the current cover data including at least one benefit, and the input data including at least one benefit and a premium indicated by the client as being affordable;
generating, by a processor associated with the at least one computer, benchmark cover data associated with proposed insurance cover for the client;
comparing, by the processor, the current cover data or the input data with the benchmark cover data in order to determine a protection level of the client, wherein the protection level is a portion or a percentage of a benchmark cover amount or benchmark cover level forming part of the benchmark cover data;
generating, by the processor, protection level data based on the comparison between the current cover data or the input data and the benchmark cover data, wherein, in the case of a comparison between the input data and the benchmark cover data, the protection level data includes optimal cover data indicative of a maximum protection level obtainable by the client based on the comparison between the input data and the benchmark cover data, the premium affordable to the client being insufficient for the client to obtain the benchmark cover amount or benchmark cover level; and
generating, by the at least one computer, output indicative of the protection level data or the optimal cover data.

2. The method according to claim 1, wherein the current cover data includes a current cover amount, and in the case of a comparison between the current cover data and the benchmark cover data, generating, by the processor, the protection level data includes expressing the current cover amount of the client as a percentage, fraction, portion or level of or relative to the benchmark cover amount.

3. The method according to claim 2, wherein the current cover data includes a plurality of benefits, each benefit including a benefit cover amount, wherein the processor is configured to calculate each benefit cover amount, and wherein the current cover amount is indicative of or takes into account all of the benefit cover amounts.

4. The method according to claim 3, wherein the current cover amount is calculated by the processor by allocating a weighting to each benefit and aggregating the benefits accordingly to arrive at the current cover amount, wherein the benchmark cover amount consists of a number of individual benchmark benefit amounts, each associated with one of the benefits, and wherein the benchmark cover amount is calculated by the processor by allocating a weighting to each benefit, being the same weighting used during calculation of the current cover amount, and aggregating the benefits accordingly to arrive at the benchmark cover amount.

5. The method according to claim 1, wherein in the case of a comparison between the input data and the benchmark cover data, generating, by the processor, the protection level data includes calculating, by the processor, the maximum protection level obtainable by the client based on the input data and the benchmark cover data, wherein the maximum protection level is a portion or a percentage of the benchmark cover amount or benchmark cover level forming part of the benchmark cover data.

6. The method according to claim 5, wherein the possible insurance policy includes a plurality of benefits, and the method includes determining, by the processor, a protection level per unit of premium for each benefit, the processor being configured to give preference to the benefit/s with a highest protection level per unit of premium in generating the protection level data so as to the maximise the maximum protection level obtainable for the premium affordable to the client.

7. The method according to claim 6, wherein the benchmark cover data includes, for each benefit, a proposed protection level, and wherein the processor is configured such that, in calculating the maximum protection level, only the benefit/s with the highest protection level per unit will be considered until the proposed protection level is reached for such benefit/s, before considering the benefit/s with a lower protection level per unit of premium.

8. The method according to claim 1, which includes transmitting the output to a communications device of the client, wherein the output includes a summary statistic providing an overview of the current cover data compared to the benchmark cover data or an overview of the maximum protection level obtainable for the premium affordable to the client.

9. The method according to claim 1, which includes calculating, by the processor, the benchmark cover amount or benchmark cover level using a needs-matched algorithm which assesses a financial need of the client which would result from the occurrence of an insured event during a specific period.

10. A system for determining a protection level and optimal insurance cover for a client, the system comprising at least one computer and a processor, the system being configured to:
receive and/or access current cover data for at least one current insurance policy associated with the client or input data in respect of a possible insurance policy for the client, the current cover data including at least one benefit, and the input data including at least one benefit and a premium indicated by the client as being affordable;
generate, by the processor, benchmark cover data associated with proposed insurance cover for the client;
compare, by the processor, the current cover data or the input data with the benchmark cover data in order to determine a protection level of the client, wherein the protection level is a portion or a percentage of a benchmark cover amount or benchmark cover level forming part of the benchmark cover data;
generate, by the processor, protection level data based on the comparison between the current cover data or the input data and the benchmark cover data, wherein, in the case of a comparison between the input data and the benchmark cover data, the protection level data includes optimal cover data indicative of a maximum protection level obtainable by the client based on the comparison between the input data and the benchmark cover data, the premium affordable to the client being insufficient for the client to obtain the benchmark cover amount or benchmark cover level; and
generate output indicative of the protection level data or the optimal cover data.

11. The system according to claim 10, wherein the current cover data includes a current cover amount, and in the case of a comparison between the current cover data and the benchmark cover data, the processor is configured to express the protection the current cover amount of the client as a percentage, fraction, portion or level of or relative to the benchmark cover amount.

12. The system according to claim 11, wherein the current cover data includes a plurality of benefits, each benefit including a benefit cover amount, wherein the processor is configured to calculate each benefit cover amount, and wherein the current cover amount is indicative of or takes into account all of the benefit cover amounts.

13. The system according to claim 12, wherein the processor is configured to calculate the current cover amount by allocating a weighting to each benefit and aggregating the benefits accordingly to arrive at the current cover amount, wherein the benchmark cover amount consists of a number of individual benchmark benefit amounts, each associated with one of the benefits, and wherein the processor is configured to calculate the benchmark cover amount by allocating a weighting to each benefit, being the same weighting used during calculation of the current cover amount, and aggregating the benefits accordingly to arrive at the benchmark cover amount.

14. The system according to claim 10, wherein in the case of a comparison between the input data and the benchmark cover data, the processor is configured to generate the protection level data by calculating the maximum protection level obtainable by the client based on the input data and the benchmark cover data, wherein the maximum protection level is a portion or a percentage of the benchmark cover amount or benchmark cover level forming part of the benchmark cover data.

15. The system according to claim 14, wherein the possible insurance policy includes a plurality of benefits, the processor being configured to determine a protection level per unit of premium for each benefit, the processor further being configured to give preference to the benefit/s with a highest protection level per unit of premium in generating the protection level data so as to the maximise the maximum protection level obtainable for the premium affordable to the client.

16. The system according to claim 15, wherein the benchmark cover data includes, for each benefit, a proposed protection level, and wherein the processor is configured such that, in calculating the maximum protection level, only the benefit/s with the highest protection level per unit will be considered until the proposed protection level is reached for such benefit/s, before considering the benefit/s with a lower protection level per unit of premium.

17. The system according to claim 16, which is configured to transmit the output to a communications device of the client, wherein the output includes a summary statistic providing an overview of the current cover data compared to the benchmark cover data or an overview of the maximum protection level obtainable for the premium affordable to the client.

18. The system according to claim 10, wherein the processor is configured to calculate the benchmark cover amount or benchmark cover level using a needs-matched algorithm which assesses a financial need of the client which would result from the occurrence of an insured event during a specific period.
